(19) United States
(12) Patent Application Publication
(10) Pub. No.: US 2010/0313684 A1
(43) Pub. Date: Dec. 16, 2010

(54) DEVICE FOR DILUTING A GAS TO BE ANALYZED WITH A DILUTION GAS

(76) Inventors: MICHAEL ARNDT, Graz (AT); Alexander Bergmann, Graz (AT); Franz Knopf, Graz (AT); Wolfgang Schindler, Graz (AT)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 12/572,501

(22) Filed: Oct. 2, 2009

(30) Foreign Application Priority Data
Oct. 2, 2008 (AT) GM 554/2008

(51) Int. Cl. G01N 1/22

(52) U.S. Cl. 73/863.11

(57) ABSTRACT

A device for the dilution of a gas to be analyzed with a dilution gas has a sample gas tube (1) and a feed (3) for the dilution gas, which open into a common line (6) for the diluted gas to be analyzed.

In order that even with large pulsatile pressures in the gas to be analyzed at the sample point no return flow of dilution air into the line of the gas to be analyzed and no uncontrolled temperature change of this gas can occur, the feed (3) for the dilution gas in the form similar to a Venturi jet (7) merges into the common line (6), the sample gas tube (1) is embodied so as to be thermally insulated with respect to the ambient air and dilution air and opens into the Venturi jet (7) just before the location with the smallest cross section.

The invention relates to a device for the dilution of a gas to be analyzed with a dilution gas, with a sample gas tube and a feed for the dilution gas, which open into a common line for the diluted gas to be analyzed.

In many applications, in the sampling of a gas to be analyzed, in particular for the analysis of particles in the gas, a dilution of the gas to be analyzed is carried out. For example, in the analysis of exhaust gas from internal combustion engines a dilution device is used in order to dilute the hot exhaust gas with air.

The gas to be analyzed is thereby fed via a pipe to the analysis device, in which pipe a feed for the dilution gas, for example, air, also opens. The gas to be analyzed that is diluted in a specific ratio is then guided in the further course of the line.

A device is disclosed in EP 1 890 125 A1, in which the lines for the gas to be analyzed and those for the dilution gas are guided spaced apart from one another up to the section in which both of the gases are mixed together. This is designed to avoid an uncontrolled heating of the dilution gas, which leads to undefinable temperature conditions at and after the mixing location.

However, the temperature of the exhaust gas is much more critical, which is intended to decrease as little as possible up to the mixing location in order to minimize the particle deposit with which one skilled in the art is familiar by “thermophoresis.” Furthermore, precautions must be taken to prevent a return flow of the dilution air into the line for the gas to be analyzed or an uncontrolled mixing with the dilution gas even with high pulsatile pressures.

The object of the present invention was therefore to improve a device as disclosed at the outset such that even with large pulsatile pressures in the gas to be analyzed no return flow into the line of the gas to be analyzed and no uncontrolled temperature change of this gas can occur.

To attain this object the device is characterized in that the feed for the dilution gas in the form similar to a Venturi jet merges into the common line, that the sample gas tube is embodied so as to be thermally insulated with respect to the ambient air and dilution air and opens into the Venturi jet just before the location with the smallest cross section. The increased momentum of the dilution air flowing into the Venturi jet, prevents the return flow of the dilution gas into the line for the gas to be analyzed, even with a pulsating analysis gas. In addition to the maintenance of controlled mixing conditions, with the thermally insulated sample gas tube the cooling of the gas to be analyzed and thus the thermophoretic deposition of particles in the sample tube for the analysis gas can also be prevented.

The prevention of the undesirable temperature change of the gas to be analyzed, preferably a prevention of cooling, is supported according to an advantageous embodiment of the invention in that the sample gas tube is surrounded by a coaxial outer tube, and a gas with essentially the temperature at the sample point of the gas to be analyzed is present in the space between the sample gas tube and outer tube.

A particularly simple solution for this provides that inlet and outlet passages for the gas to be analyzed are present in the space between the sample gas tube and outer tube. It is thus possible without major additional expenditure to keep the temperature around the line of the gas to be analyzed at the level thereof.

Advantageously, a further embodiment of the invention is characterized in that the end piece of the sample gas tube is aligned coaxially to the Venturi jet.

In order to intensify the effect of the Venturi jet, it is preferably provided that the end piece of the sample gas tube is embodied to be geometrically similar to the Venturi jet.

Another advantageous embodiment of the device according to the invention is characterized in that the feed for the dilution gas comprises a section running perpendicular to the sample gas tube, which section opens into a chamber surrounding this sample gas tube in an annular manner, the outlet of which chamber merges into the common line in the form of a Venturi jet.

It can be provided thereby that the axis of the section running perpendicular to the sample gas tube does not intersect with the axis of the sample gas tube.

It is preferably also provided that the end piece of the sample gas tube has an internal cross section tapering towards the opening.

With the arrangement described, in general a minimal heating of the dilution gas will also take place. However, this is not an essential physico-technical property of the system nor is it a characterizing feature of the invention.

In the following description, the invention is explained in more detail based on a preferred exemplary embodiment and with reference to the attached drawings.

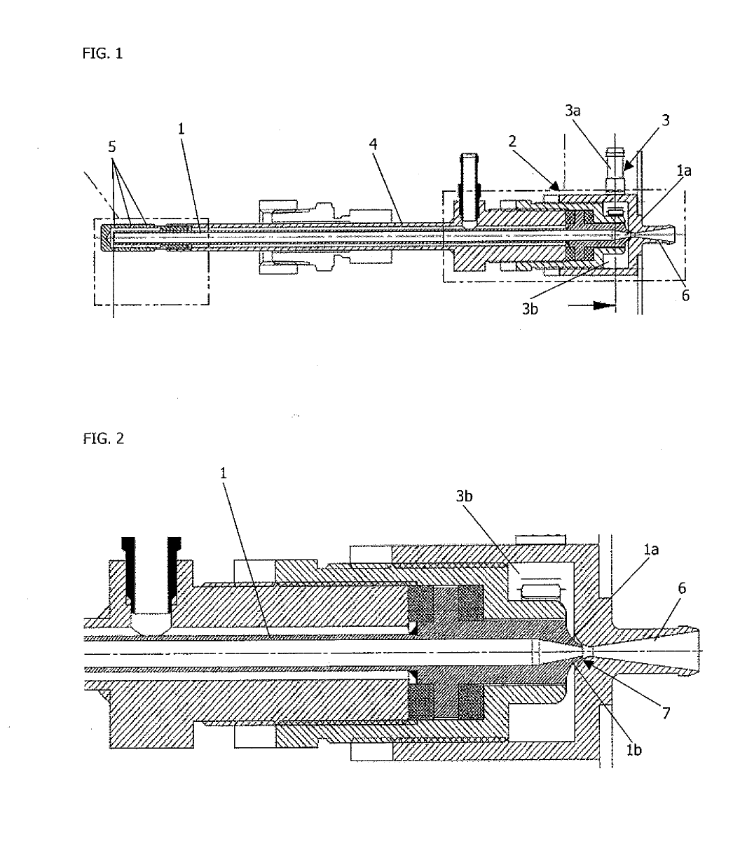

FIG. 1 thereby shows a longitudinal section through a device according to the invention, and FIG. 2 is a representation of the mixing section of the device of FIG. 1 on an enlarged scale, likewise in longitudinal section.

The device shown in FIG. 1 has a tube 1, which can be inserted into a volume in which the gas to be analyzed is located. This volume can itself be a pipe or the like, for example, the exhaust gas system of an internal combustion engine. This tube 1 for removing a sample of the gas to be analyzed leads, preferably in a straight embodiment, to an area 2, in which a dilution gas is added. Preferably, the end piece 1a of the sample gas tube 1 has an internal cross section that tapers towards the opening.

The dilution gas, in the case of vehicle applications typically filtered air or purified compressed air, is fed into the area 2 via a feed 3. The feed 3 for the dilution gas has a section 3a running perpendicular to the sample gas tube 1, which section opens into a chamber 3b surrounding this sample gas tube 1 in the area 2 in an annular manner. The straight section 3a of the feed 3 thereby preferably runs such that the axis thereof does not intersect with the axis of the sample gas tube 1.

Advantageously, the tube 1 for the gas to be analyzed is surrounded by a coaxial outer tube 4, so that a volume is defined between these two tubes 1, 4 in which a gas with essentially the temperature of the gas to be analyzed can be inserted. The sample gas tube 1 is thus thermally insulated with respect to the ambient air and dilution air in a simple manner. Preferably, this gas is part of the gas to be analyzed, and in order to fill the volume between the tubes 1, 4 therewith, the outer tube 4 has openings 5 as inlet and outlet passages for the gas to be analyzed in the space between the sample gas tube 1 and the outer tube 4.

The actual mixing area of the gas to be analyzed and the dilution gas in the area 2 is embodied in the form of a Venturi jet. The outlet out of the chamber 3b for the dilution gas, which merges into the common line 6 for the mixture of the gas to be analyzed and the dilution gas, is embodied as a concave section 7 with a cross section initially becoming smaller in the direction of flow of the dilution gas and then with a cross section increasing again. Just before the point of the smallest cross section, the sample gas tube 1 thereby opens into the section of the mixing area 2 embodied as a Venturi jet.

Advantageously, the end piece lb of the sample gas tube 1 is thereby aligned coaxially to the Venturi jet and is advantageously also embodied to be geometrically similar to the Venturi jet, for which the outside of the end piece lb is embodied in a concave manner.

1. A device for the dilution of a gas to be analyzed with a dilution gas, with a sample gas tube and a feed for the dilution gas, which open into a common line for the diluted gas to be analyzed, wherein the feed for the dilution gas in the form similar to a Venturi jet merges into the common line, that the sample gas tube is embodied so as to be thermally insulated with respect to the ambient air and dilution air and opens into the Venturi jet just before the location with the smallest cross section.

2. The device according to claim 1, characterized in that the sample gas tube is surrounded by a coaxial outer tube, and a gas with essentially the temperature of the gas to be analyzed is present in the space between the sample gas tube and outer tube.

3. The device according to claim 2, wherein inlet and outlet passages for the gas to be analyzed are present in the space between the sample gas tube and outer tube.

4. The device according to claim 1, wherein the end piece of the sample gas tube is aligned coaxially to the Venturi jet.

5. The device according to claim 4, wherein the end piece of the sample gas tube is embodied to be geometrically similar to the Venturi jet.

6. The device according to claim 1, wherein the feed for the dilution gas comprises a section running perpendicular to the sample gas tube, which section opens into a chamber surrounding this sample gas tube in an annular manner, the outlet of which chamber merges into the common line in the form of a Venturi jet.

7. The device according to claim 6, wherein the axis of the section running perpendicular to the sample gas tube does not intersect with the axis of the sample gas tube.

8. The device according to claim 1, wherein the end piece of the sample gas tube has an internal cross section tapering towards the opening.
